(19) United States
(12) Patent Application Publication
(10) Pub. No.: US 2025/0350146 A1
(43) Pub. Date: Nov. 13, 2025

(54) ENERGY STORAGE AND POWER GENERATION SYSTEM

(71) Applicant: Rizhao Xiqigongmao Co., Ltd., Rizhao City (CN)

(72) Inventors: Shouben Li, Rizhao City (CN); Shouyue Li, Rizhao City (CN); Mingde Li, Rizhao City (CN); Tianyu Li, Rizhao City (CN); Yanmei Lu, Rizhao City (CN)

(73) Assignee: Rizhao Xiqigongmao Co., Ltd., Rizhao City (CN)

(21) Appl. No.: 18/889,531

(22) Filed: Sep. 19, 2024

(30) Foreign Application Priority Data
May 9, 2024 (CN) 202410571285.8

(51) Int. Cl. H02J 15/00

(52) U.S. Cl. CPC H02J 15/00

(57) ABSTRACT

Disclosed is an energy storage and power generation system, comprising: an electric energy conversion device for converting electric energy into thermal energy or collecting thermal energy; a thermal storage device for storing the thermal energy converted by the electric energy conversion device or the thermal energy collected by the thermal collection device; a steam power generation device for generating electricity from stored heat energy; and a pipeline filled with a first heat-conducting medium, through which the electric energy conversion device or the thermal collection device, the thermal storage device, and the steam power generation device are connected. The energy storage and power generation system of the invention can be stored and used on a large scale according to actual needs and peak and valley conditions. Fundamentally change the pressure on the power grid, fundamentally get rid of the dependence on coal, oil, natural gas, etc., completely change the energy structure, completely reduce carbon emissions, realize the goal of carbon peak in advance, and truly realize green sustainable development.

### CROSS-REFERENCE TO RELATED APPLICATION

The disclosure is based upon and claims priority to Chinese Patent Application No. 202410571285.8, filed on May 9, 2024, the entire contents thereof are incorporated herein by reference.

### TECHNICAL FIELD

The disclosure relates to the field of energy storage technology, and particularly to a large capacity, low-cost, safe, green and environmentally friendly energy storage and power generation system.

### BACKGROUND

With the use of photovoltaic power generation, wind power generation, hydropower generation, nuclear power generation and the like, the phenomenon of electricity peak and valley is becoming increasingly prominent, resulting in a large overload on the grid during the peak period of electricity generation. At the same time, there is a shortage of electricity during peak periods, and serious energy waste occurs during valley periods. The key to solving this problem is to vigorously develop the energy storage industry, store excess electricity in a scientific form and manner during peak periods of power generation and low periods of electricity consumption, and timely convert and supplement it during peak periods of power generation and high periods of electricity consumption, playing a “peak” role.

The current main energy storage methods include: 1) pumped storage, which has the disadvantages of relying on geographical conditions and requiring high hydropower stations, resulting in high construction costs for pumped storage stations, and it has a significant impact on geography and terrain; 2) compressed air energy storage, which has the disadvantages of being limited by geographical conditions, limited energy storage capacity, high investment, huge explosive danger, significant safety hazards, and difficulty in large-scale and commercial use; 3) chemical energy storage, which has the disadvantages of low energy storage, high construction costs, significant safety hazards, short service life, and serious environmental pollution caused by both production and disposal processes; 4) phase change energy storage, which has the disadvantages of complex process, high price, easy aging, low thermal conductivity, low energy storage, easy volatilization, high flammability risk factor, and difficult to promote.

The current development of energy storage industry is stagnant because the construction cost of energy storage facilities is high, the energy storage capacity is too low, and the service life is short. There are serious safety risks and environmental pollution, and it is not economical to promote large-scale applications. There is no set of technological equipment that can simultaneously meet the needs of energy storage: low cost, convenient construction, huge storage capacity, long service life, green and pollution-free, no potential safety hazards, easy to promote, can be staggered storage, cross seasonal long-term storage, can convert electric energy into thermal energy for storage, and can also collect and store the remaining thermal energy generated in the production process of enterprises. It can be stored in small amounts or almost unlimited amounts, with convenient storage and use, not affected by factors such as season, climate, geographical location, etc. The storage medium can be used infinitely, can be promoted on a large scale, and has high economic benefits. This is a global challenge.

### SUMMARY

The disclosure provides an energy storage and power generation system.

The disclosure relates to an energy storage and power generation system, which includes: an electric energy conversion device or thermal energy collection device for converting electric energy into heat energy or collecting thermal energy; a thermal energy storage device for storing the thermal energy converted by the electric energy conversion device or collected by the thermal energy collection device; a steam power generation device for generating electricity using the stored thermal energy; and a pipeline filled with a first heat-conducting medium through the electric energy conversion device or the thermal energy collection device, the thermal energy storage device and the steam power generation device.

According to one embodiment of the disclosure, the electric energy conversion device includes at least one of an electric heating unit and an electromagnetic unit. The electric energy is converted into heat energy by at least one of the electric heating unit and the electromagnetic unit and transferred to the first heat-conducting medium in the pipeline.

In another embodiment of the disclosure, the thermal energy storage device includes one or more independent units.

In another embodiment of the disclosure, the thermal energy storage device includes a second heat-conducting medium for storing thermal energy and heat exchange with the first heat-conducting medium in the pipeline.

In another embodiment of the disclosure, an insulation unit is provided around the heat storage device.

In another embodiment of the disclosure, one or more temperature measurement units are provided in the electric energy conversion device, the thermal energy collection device and the thermal energy storage device.

In another embodiment of the disclosure, a steam power generation device uses the heat energy transferred by the first thermal-conducting medium in the pipeline for power generation.

In another embodiment of the disclosure, the residual heat energy generated by the steam power generation device is transferred to the thermal energy collection device.

In another embodiment of the disclosure, the pipeline is equipped with one or more control valves and one or more high-temperature circulation pumps in the electric energy conversion device, thermal energy collection device, and steam power generation device.

In another embodiment of the disclosure, the pipeline is a stainless steel pipeline.

The system of disclosure first converts electric energy into thermal energy by the electric energy conversion device, or a heat collection device that collects residual heat of the enterprise. In the system of the disclosure, the thermal energy converted from the electric energy or collected from the residual heat of the enterprise is used to heat the heat-conducting medium in the pipeline and transported through the pipeline to the thermal storage device to store the thermal energy in the heat-conducting medium in the thermal storage device. When needed, the thermal energy in the medium is again transferred to the steam power generation device for power generation through the “heat transfer substance” in the pipeline. The remaining heat after the generation of electricity can be used by businesses that require steam, or it can be recirculated.

The disclosure relies on pure physical principles to fundamentally solve the global problem of energy storage. The advantages of the disclosure include: 1) huge storage capacity, realizing large-scale and ultra large scale energy storage, which can form large-scale and ultra large scale artificial geothermal resources; 2) the ability to convert electric energy into thermal energy and store it for use, reducing electric energy waste, with high energy conversion rate and huge economic benefits; 3) the ability to collect and store residual thermal energy generated in the production process of enterprises, with almost no cost and extremely high economic benefits, greatly reducing resource waste and carbon emissions (However, other energy storage methods are unable to collect and store the remaining thermal energy generated during the production process of the enterprise.); 4) low cost storage, storage media that are extremely cheap and easy to obtain, can be used infinitely, with low cost, convenient construction, and easy promotion; 5) the energy storage and reuse process of the disclosure has no combustion or chemical reaction steps, and no addition of any chemical additives, truly achieving green and pollution-free; 6) no potential danger, achieving absolute safety in the energy storage industry; 7) full time storage, capable of short-term off peak storage or long-term storage across seasons; 8) all environment storage, unaffected by factors such as season, climate, and geographical location; 9) low energy consumption storage, the storage method of the disclosure has less thermal energy loss and low energy loss rate; 10) the ability to store both small amounts and almost unlimited amounts. The system of the disclosure can be widely promoted and has extremely high economic benefits.

With the energy storage and power generation system of the invention, the country can vigorously develop solar, wind, water, nuclear and other power generation industries, and store and use them on a large scale according to actual needs and peak and valley conditions. This fundamentally changes the grid pressure, fundamentally breaks away from dependence on coal, oil, natural gas, etc., fundamentally changes the energy structure, fundamentally reduces carbon emissions, and realizes the goal of carbon peaking in advance, truly realizing green sustainable development.

### BRIEF DESCRIPTION OF THE DRAWINGS

FIG. 1 is a schematic diagram of the structure of an energy storage and power generation system according to one exemplary embodiment of the disclosure.

The reference signs are described as follows:
1—electric energy conversion device
2—thermal storage system
3—steam power generation device
4—pipeline
5—control valve
6—high temperature circulation pump
7—electric heating unit
8—temperature measurement unit
9—second heat-conducting medium

### DETAILED DESCRIPTION

Typical examples to illustrate the features and advantages of the disclosure will be described in detail below. It should be understood that the disclosure can have various variations in different examples, all of which do not deviate from the scope of the disclosure, and the descriptions and drawings thereof are essentially for explanation purposes rather than being used to limit the disclosure.

In the following description of different exemplary embodiments of the disclosure, reference is made to the accompanying drawings, which form a part of the disclosure, and in which different exemplary structures, systems, and steps that can implement various aspects of the disclosure are shown by way of example. It should be understood that other specific schemes of components, structures, exemplary devices, systems, and steps may be used, and structural and functional modifications may be made without departing from the scope of the disclosure. Furthermore, although terms such as “electric energy conversion device or heat collection device,” “heat storage device”, “steam power generation device”, “control valve”, “high temperature pump”, “air compressor”, “heat-first heat-conducting medium”, and “medium” may be used in the specification to describe exemplary features and elements of the disclosure, these terms are used in this specification only for convenience, and any content of this specification should not be construed as requiring a particular three-dimensional direction of structure falling within the scope of the disclosure based on the direction described in the examples of the figures.

As described above, the energy storage and power generation system in this embodiment is explained by way of example of converting electric energy into thermal energy for storage and then back to electric energy. It should be obvious to those skilled in the art that it also includes applying the relevant design of the disclosure to collecting the residual heat from industrial production processes and storing them so as to convert them back to electricity or other forms of usable energy.

The energy storage and power generation system described in the present embodiment is described as using “heat-conducting medium” as a carrier for energy transmission, but it is not limited to only using this one way. It should be understood by those skilled in the art that it also includes using any device capable of converting electric energy into thermal energy and storing it in the medium.

The storage medium in the energy storage and power generation system of this embodiment is not limited to one type, and it is easy for those skilled in the art to understand that it also includes other solid or liquid substances capable of absorbing, storing, and releasing thermal energy.

The embodiment of the disclosure illustrates the use of stored thermal energy in a power generation system by converting the stored thermal energy into electric energy through a steam power generation system, but is not limited to this use. It should be understood by those skilled in the art that it also includes various other usable methods such as converting stored thermal energy into hot water energy, steam energy, hot air energy and the like.

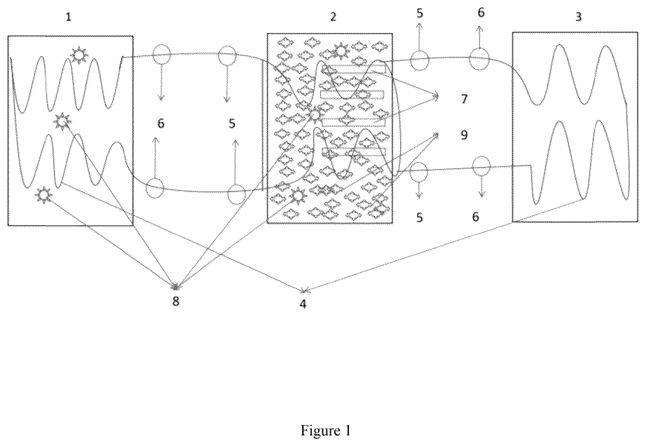

The disclosure relates to an energy storage and power generation system, which includes: an electric energy conversion device or thermal energy collection device for converting electric energy into heat energy or collecting residual heat produced by industrial enterprises, such as thermal power plants and steel factories; a thermal energy storage device for storing the thermal energy converted by the electric energy conversion device or collected by the thermal energy collection device; a steam power generation device for generating electricity using the stored thermal energy; and a pipeline filled with a first heat-conducting medium (not shown in FIG. 1) through the electric energy conversion device or the thermal energy collection device, the thermal energy storage device and the steam power generation device. The function of the first heat-conducting medium is to transfer the thermal energy between the electric energy conversion device or the thermal collection device, the thermal storage device, and the steam power generation device, realizing the transformation of energy. The first heat-conducting medium can be any liquid or gaseous flowing material, such as but not limited to oils, air and the like.

The energy storage and power generation system of the disclosure first converts the electric energy into thermal energy by the electric energy conversion device, or collect heat energy by the heat collection device. The electric energy conversion device can be any device that converts electric energy into heat energy and directly transfers the converted heat energy to the first heat-conducting medium inside the pipeline for storage. For example, electromagnetic heating or other heating devices can be wrapped around the outside of the pipeline in the electric energy conversion device to convert electrical energy into thermal energy and transfer it to the first heat-conducting medium inside the pipeline. Alternatively, electric heating rods can be used for heating. When using an electric heating rod for heating, the electric heating rod can be directly installed in the thermal energy storage device to reduce the loss of heat transfer process. Of course, when using an electric heating rod for heating, setting the electric heating rod outside the thermal energy storage device can also achieve the purpose of the disclosure. The electric energy conversion device can adopt one method of converting electric energy into thermal energy, or multiple methods of converting electric energy into thermal energy can be used simultaneously. The thermal energy collection device can be any suitable device capable of collecting thermal energy, and the collected thermal energy is transferred to the first heat-conducting medium inside the pipeline. One or more control valves, one or more high-temperature circulation pumps, and other supporting equipment are installed at appropriate positions in the pipelines of the electric energy conversion device or thermal energy collection device. A temperature measurement unit can be installed at a suitable position in the pipeline of the electric energy conversion device or thermal energy collection device to measure and control the temperature of the first heat-conducting medium inside the pipeline.

The converted or collected thermal energy is transferred to the thermal storage device through the first heat-conducting medium in the pipeline. The thermal storage device includes a second heat-conducting medium for storing thermal energy. The thermal storage device can be one or more independent units with a certain volume. When there are multiple independent units, they are connected by pipelines and valves, which can maintain the independence of each unit and realize the connection between them. According to energy storage needs, one unit can be used separately or multiple units can be used simultaneously. The second heat-conducting medium can be any material that can store thermal energy, such as other solid or liquid substances capable of absorbing, storing, and releasing thermal energy. The second heat-conducting medium can theoretically be used infinitely. The physical structure of the second heat-conducting medium can be adjusted according to the energy storage needs. The temperature of the second heat-conducting medium after energy storage can be controlled within 1 degree Celsius to several thousand degrees Celsius based on the energy storage needs and the composition of the second heat-conducting medium. The second heat-conducting medium can come into contact with the pipeline to achieve heat exchange with the first heat-conducting medium inside the pipeline. The first heat-conducting medium and the second heat-conducting medium in the energy storage and power generation system of the disclosure can be any suitable material. Therefore, this kind of media has many advantages: extremely cheap materials, easy access, extremely low investment, huge energy storage, no pollution, absolute green environmental protection, no potential safety hazards, large-scale promotion, anti-aging, unlimited use, etc. It solves all the problems in the current field of energy storage.

The periphery of the thermal energy storage device can be equipped with insulation units as needed for heat preservation treatment, such as insulating cotton and vacuum. One or multiple temperature measurement units are set in a suitable position inside to detect the temperature within the thermal energy storage device.

The thermal energy storage device provides the steam power generation device with thermal energy through the first heat-conducting medium in the pipeline. The steam power generation device uses the transferred thermal energy to generate steam power. For example, the thermal energy can be directly converted into various other usable forms of energy such as hot water, steam, and hot air energy for power generation. After power generation, the residual heat can be collected by the thermal energy collection device for recycling or supplied to enterprises that need steam. A suitable position in the pipeline inside the steam power generation device may be provided with one or more control valves and/or one or more high temperature circulation pumps and other auxiliary equipment.

The pipeline in the energy storage and power generation system of the disclosure may be a stainless steel pipeline or any high-temperature resistant pipeline.

The energy storage and power generation system of the disclosure relies on pure physical principles to fundamentally solve the global problem of energy storage. The disclosure can not only convert electric energy into thermal energy and store it, but also collect the residual heat generated by enterprise production and store it, saving a large amount of energy. There is no combustion process in the energy storage process and recycling process of the disclosure, no chemical additives are added, there is no chemical reaction process, and there is no safety hazard, realizing absolute safety in the energy storage industry, while meeting huge storage capacity, low cost, extremely low investment, low energy loss rate, high economic benefits, no chemical medium, green and safe, pollution-free, easy to popularize, can be stored and used at any time, cross-seasonal long-term storage, without being affected by seasonal, climate, geographical location and other factors. It can not only convert electric energy into thermal energy for storage, but also collect residual heat generated during the production process of enterprises and store it. It can be stored in small quantities or almost unlimited amounts, making it convenient to use and the storage medium can be reused indefinitely, allowing for large-scale promotion. The global challenges in the energy storage industry are solved.

The energy conversion rate of the system of the invention is about 60% to 86%, and the output value is about 1.5 to 4 times that of the original energy output value, with great economic benefits.

Of course, the energy storage and power generation system of the disclosure may also include any other appropriate device.

The following describes the disclosure in detail, as illustrated in the accompanying drawings.

As shown in FIG. 1, the energy storage and power generation system in this embodiment is illustrated by converting electrical energy into thermal energy and storing it, and then converting the stored thermal energy back into electrical energy. Thus, it should be obvious to those skilled in the art that a variety of modifications, additions, substitutions, deletions or other changes may be made to the specific embodiment described above or below in order to apply the relevant design of the disclosure to other types of energy storage processes, all within the scope of the principle of the energy storage and power generation system presented in the invention.

As shown in FIG. 1, in this embodiment, the energy storage and power generation system includes: an electric energy conversion device 1, a thermal energy storage device 2, a steam power generation device 3, a pipeline 4, a control valve 5, a high-temperature circulation pump 6, an electric heating unit 7, a temperature measurement unit 8, and a second medium 9.

FIG. 1 represents a schematic diagram of the structure of an energy storage and power generation system that can embody the principles of the disclosure. The following provides a detailed description of the structure, connection methods, and functional relationships of the main components of the energy storage and power generation system proposed by the disclosure, in conjunction with the accompanying drawings.

As shown in FIG. 1, in the embodiment, the electric energy conversion device 1 is disposed on a base and the first heat-conducting medium within the pipeline 4 transfers thermal energy from the electric energy conversion device 1 to the thermal energy storage device 2. The second heat-conducting medium 9 of the thermal energy storage device 2 absorbs the thermal energy transferred by the electric energy conversion device 1 and stores it. The pipeline 4 of the thermal energy storage device 2 transfers the thermal energy to the steam power generation device 3 through the first heat-conducting medium, and the steam power generation device 3 generates electricity using the thermal energy stored in the thermal energy storage device 2. The control valve 5 and high temperature circulation pump 6 are started or stopped as needed.

The energy conversion device 1 can be made of stainless steel or other high temperature resistant materials, and is heated by electromagnetic means or other ways. The thermal storage device 2 can be divided into several storage units inside, the volume and shape of which can be determined according to actual needs, each unit being independently controlled, and one or more units are activated according to actual needs. The distribution density of pipelines 4 in the thermal storage device 2 is determined according to need. The “medium” 9 described above is filled in the thermal storage device 2, which completely and fully wraps the pipeline 4. The purpose is to promote the transfer of heat as much as possible. The temperature measurement unit 8 is disposed in the energy conversion device 1 and the thermal storage device 2 for detecting the temperature inside the device. The electric heating unit 7 (for example electric heating rod) is set in the thermal storage device 2 to convert electric energy into heat energy.

After the steam power unit 3 is started, the pipeline 4 in the heat storage device 2 transfers the heat energy stored in the heat storage device 2 to the steam power unit 3 to start the steam power generation. The residual heat generated by the steam power generation can be supplied to enterprises using steam or recycled again to maximize the efficiency of energy use.

The disclosure also includes other auxiliary devices, such as mounting brackets and accessories.

It should be noted that the energy storage and power generation system shown in the drawings and described in this specification is merely an example of one embodiment of the disclosure. Several examples of the many kinds of energy storage and power generation systems that can be practiced using the principles of the invention are shown. It should be clearly understood that the principles of the invention are not limited to any details or components of a power generation system with energy storage as shown in the figures or described in this specification.

The above describes and/or illustrates exemplary examples of the energy storage and power generation system proposed by the disclosure. But the embodiment described here is not limited to the specific embodiment, on the contrary, each component and/or step of an embodiment can be used independently and separately from other components and/or steps described here. Each component and/or step of one embodiment may also be combined with other components and/or steps of another embodiment. The terms “heat-conducting medium”, “unit”, “collection”, “transmission”, “conversion” are used to indicate open-ended inclusion and refer to elements/components etc., in addition to those listed. In addition, the terms in the claims and description are only used as markers and do not impose a numerical limitation on their objects.

The above disclosed exemplary embodiment of the disclosure is provided merely to aid in the understanding of the disclosure. Exemplary embodiment has not been shown by a thorough description of all the details, nor does it limit the disclosure to only the specific examples as disclosed herein. Obviously, many modifications and variations may be made according to the content of this specification. The present specification selects and specifically describes the above content. The following claims are provided to better explain the principles and practical applications of the disclosure, so that those skilled in the art can fully understand and use the disclosure. The disclosure is limited only by the claims and their entire scope and equivalents.

What is claimed is:

1. An energy storage and power generation system, comrpising:
an electric energy conversion device or thermal energy collection device for converting electric energy into heat energy or collecting thermal energy;
a thermal energy storage device for storing the thermal energy converted by the electric energy conversion device or collected by the thermal energy collection device;
a steam power generation device for generating electricity using the stored thermal energy; and
a pipeline filled with a first heat-conducting medium through the electric energy conversion device or the thermal energy collection device, the thermal energy storage device and the steam power generation device.

2. The energy storage and power generation system according to claim 1, wherein the electric energy conversion device comprises at least one of an electric heating unit and an electromagnetic unit, which converts electricity energy into heat energy and transferred it to the first heat-conducting medium in the pipeline.

3. The energy storage and power generation system according to claim 1, wherein the thermal energy storage device comprises one or more independent units.

4. The energy storage and power generation system according to claim 1, wherein the thermal energy storage device comprises a second heat-conducting medium for storing thermal energy and heat exchange with the first heat-conducting medium in the pipeline.

5. The energy storage and power generation system according to claim 1, wherein an insulation unit is provided around the heat storage device.

6. The energy storage and power generation system according to claim 1, wherein one or more temperature measurement units are provided in the electric energy conversion device, the thermal energy collection device and the thermal energy storage device.

7. The energy storage and power generation system according to claim 1, wherein a steam power generation device uses the heat energy transferred by the first thermal-conducting medium in the pipeline for power generation.

8. The energy storage and power generation system according to claim 1, wherein the residual heat energy generated by the steam power generation device is transferred to the thermal energy collection device.

9. The energy storage and power generation system according to claim 1, wherein the pipeline is equipped with one or more control valves and one or more high-temperature circulation pumps in the electric energy conversion device, thermal energy collection device, and steam power generation device.

10. The energy storage and power generation system according to claim 1, wherein the pipeline is a stainless steel pipeline.
